(19) United States
(12) Patent Application Publication
(10) Pub. No.: US 2004/0122663 A1
(43) Pub. Date: Jun. 24, 2004

(54) Apparatus and method for switching audio mode automatically

(76) Inventors: Jun Han Ahn, Seoul (KR); So Myung Kim, Seoul (KR)

Correspondence Address: BIRCH STEWART KOLASCH & BIRCH, PO BOX 747, FALLS CHURCH, VA, 22040-0747, US

(21) Appl. No.: 10/733,383

(22) Filed: Dec. 12, 2003

(30) Foreign Application Priority Data
Dec. 14, 2002 (KR) P2002-79960

(51) Int. Cl. G10L 19/12

(52) U.S. Cl. 704/221

(57) ABSTRACT

There is provided an audio mode automatic switching method, which automatically recognizes kinds of input audios to automatically switch and output audio mode. The method includes the steps of: collecting sample audio data in advance, then analyzing a feature of the sample audio data and extracting features according to kinds of audios; and if a listening audio is inputted, pattern-matching a feature of the listening audio with the features according to the kinds of audios in the step (a) to determine the kind of the listening audio and automatically switch the audio mode according to the determined audio kind.

This application claims the benefit of the Korean Application No. P2002-79960 filed on Dec. 10, 2003, which is hereby incorporated by reference.

### BACKGROUND OF THE INVENTION

1. Field of the Invention

The present invention relates to an apparatus and method for switching audio mode automatically.

2. Description of the Related Art

Recently, the development and importance of audio-related devices such as Digital TV, Radio, CDP, MP3, etc. are increased much more than any other time of the past.

In these respective devices, audio is played only in an independent audio mode despite various kinds of audios (ex. music, drama, sports, and so forth), and also a user who wants to hear an audio has to manually control the audio mode (ex. music, drama, sports and so forth) according to the kinds of the audios that the user wants to hear.

Thus, since the conventional devices play the audio only in an independent audio mode, it does not meet users' desire intended to hear such an audio in accordance with a corresponding audio mode, or a listener by oneself has to manually operate the audio mode inconveniently.

### SUMMARY OF THE INVENTION

Accordingly, the present invention is directed to an apparatus and method for automatically switching audio mode that substantially obviates one or more problems due to limitations and disadvantages of the related art.

An object of the present invention is to provide an apparatus and method for automatically switching audio mode in which kinds of audios are automatically recognized to automatically switch audio mode, thereby maximizing the listener's convenience.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for automatically switching an audio mode, the apparatus comprising: a preprocessing part for collecting sample audio data in advance, then analyzing a feature of the sample audio data and extracting features according to kinds of audios; and an audio mode determining part for pattern-matching an input listening audio feature with the features according to the kinds of audios to determine the kind of the listening audio and automatically switch the audio mode according to the determined audio kind.

In the above, the preprocessing part comprises: a sample audio database for collecting and storing the sample audio data; a first feature extracting part for extracting the features of the sample audio data stored in the sample audio database; and an audio kinds sorting part for sorting the features of the sample audio data extracted from the first feature extracting part according to preset audio kinds.

The first feature extracting part extracts the features of the sample audio data by using any one selected from the group consisting of ICA (Independent Component Analysis), PCA (Principle Component Analysis), clustering, and vector quantization.

The audio kinds sorting part sorts the audio kinds by using either a learning model or a statistical model.

The audio mode determining part comprises: a second feature extracting part for extracting the feature of the listening audio if the listening audio is inputted; a pattern matching part for pattern-matching the feature of the listening audio with the features according to the kinds of audios sorted by the preprocessing part; an audio sorting determining part for determining an audio kind that is the most similar to the feature of the listening audio from a result of the pattern-matching of the pattern-matching part; and an audio mode switching part for automatically switching a current listening audio by using an audio mode of the audio kind determined from the audio sorting determining part.

The second feature extracting part extracts the features of the listening audio by using any one selected from the group consisting of ICA (Independent Component Analysis), PCA (Principle Component Analysis), clustering, and vector quantization.

The pattern-matching part utilizes any one selected from the group consisting of dynamic programming, HMM (Hidden Markov Model) method, and neutral network method.

In another aspect of the present invention, there is provided a method for automatically switching audio mode, the method comprising the steps of: (a) collecting sample audio data in advance, then analyzing a feature of the sample audio data and extracting features according to kinds of audios; and (b) if a listening audio is inputted, pattern-matching a feature of the listening audio with the features according to the kinds of audios in the step (a) to determine the kind of the listening audio and automatically switch the audio mode according to the determined audio kind.

In the above method, the step (a) comprises the steps of: collecting and storing the sample audio data; extracting features of the stored sample audio data; and sorting the features of the extracted sample audio data according to preset audio kinds.

The step (b) comprises the steps of: extracting the feature of the listening audio if the listening audio is inputted; pattern-matching the feature of the listening audio with the features according to the kinds of audios sorted in the step (a); determining an audio kind that is the most similar to the feature of the listening audio from the pattern-matching; and automatically switching a current listening audio by using an audio mode of the determined audio kind.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating an audio mode automatic switching apparatus according to the present invention; and

FIG. 2 is waveforms exemplarily showing all sorts of features and pattern matching in FIG. 1.

### DETAILED DESCRIPTION OF THE INVENTION

Reference will now be made in detail to the preferred embodiments of the present invention to achieve the objects, with examples of which are illustrated in the accompanying drawings. The inventive construction and operation shown in and illustrated by the drawings are given as only an embodiment, and the inventive technical spirit, main construction and operation are not restricted by the embodiment.

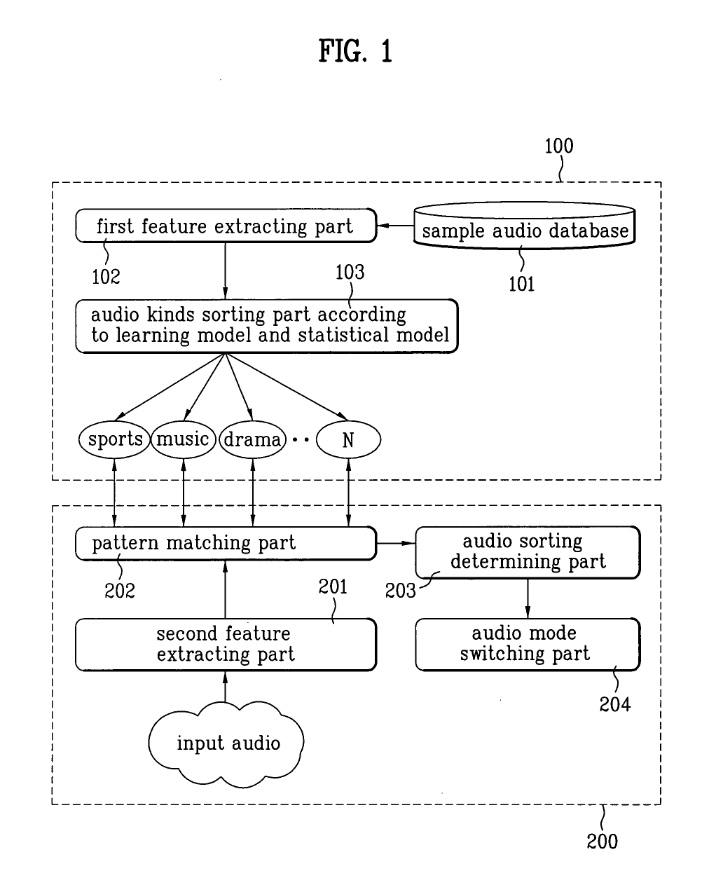

FIG. 1 is a block diagram illustrating an audio mode automatic switching apparatus according to the present invention. Referring to FIG. 1, the automatic switching apparatus includes: a preprocessing part 100 for collecting sample audio data in advance, then analyzing a feature of the sample audio data and extracting features according to kinds of audios; and an audio mode determining part 200 for extracting a feature from an input listening audio, comparing the extracted feature with the features according to kinds of audios of the preprocessing part 100 to determine the mode of the listening audio and automatically switch the audio mode into the determined audio mode.

In the above, the preprocessing part 100 includes: a sample audio database 101 for collecting and storing the sample audio data; a first feature extracting part 102 for extracting the features of the sample audio data stored in the sample audio database 101; and an audio kinds sorting part 103 for sorting the features of the sample audio data from an extracting result of the first feature extracting part through a learning mode or a statistical model.

The audio mode determining part 200 includes: a second feature extracting part 201 for extracting the feature of an input listening audio; a pattern matching part 202 for pattern-matching the feature of the audio extracted from the second feature extracting part 201 with the features according to the kinds of audios sorted by the preprocessing part 100 so as to judge that the listening audio is the most similar to the sample audio of which audio kind; an audio sorting determining part 203 for determining an audio kind that is the most similar to the feature of the listening audio from a result of the pattern-matching part 202; and an audio mode switching part 204 for automatically switching a current listening audio into the audio mode of the determined audio kind.

In the inventive apparatus constructed as above, the preprocessing part 100 collects sample data to perform necessary operations in advance, while the audio mode determining part 200 performs necessary operations as an audio that a user wants to heat is inputted.

In other words, the sample audio database 101 of the preprocessing part 100 collects and stores sample data in advance as an aggregate of the sample data that can be representative of the audio kinds.

The first feature extracting part 102 extracts features according to audio kinds from the sample audio data stored in the sample audio database 101. In other words, the first feature extracting part 102 extracts the feature of each sample audio data so as to create a representative model according to the audio kinds from a number of sample audio data. In this feature extraction, the feature is extracted through the following statistical techniques as a value from which relation between several variables or patterns are caught and the information of the variables can be represented. In other words, in the first feature extracting part 102, any method would be used if the feature of the sample audio data can be extracted. For instance, there are ICA (Independent Component Analysis), PCA (Principle Component Analysis), clustering, vector quantization method and the like. The first feature extracting part 102 is a public technology, and since it can be applied more widely and variously, it is not restricted only to the above presented examples.

The methods of ICA and PCA are used for computing the number of factors to the minimum and maximizing the information contained in the variables. The method of clustering groups similar some among values given for observance and grasps the characteristic of each group to help the understanding on the whole data structure, and has K-means algorithm as the representative thereof. Also, the method of vector quantization divides voice spectrum by vectors and stores an index value of a pattern that accords with in each code table. If a pattern that accords with a real value does not exist on the code table, the index value of the most similar pattern and a difference value are transmitted.

The audio kinds sorting part 103 sorts the features of the sample audio data according to preset audio kinds by using a learning model, a statistical model and so forth. In other words, the audio kinds sorting part 103 extracts the features from a few hundred to a few thousand sample audio data, and sorts the features of the sample audio data according to a few sample audio kinds. For instance, the audio kinds can be classified into sports, drama, music, etc.

In the meanwhile, if a listening audio is inputted, the second feature extracting part 201 of the audio mode determining part 200 extracts the listening audio and outputs the extracted feature to the pattern-matching part 202. Herein, the second feature extracting part 201 can use the same algorithm as or a different algorithm than that used in the first feature extracting part 102 of the preprocessing part 100.

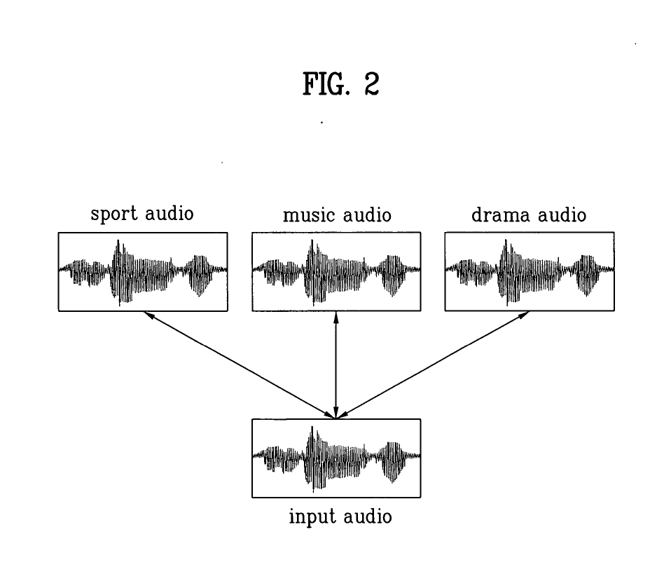

The pattern-matching part 202 pattern-matches the feature of the audio extracted from the second feature extracting part 201 with the features according to the kinds of audios sorted by the preprocessing part 100 so as to judge that the listening audio is the most similar to the sample audio of which audio kind, and outputs the matching result to the audio sorting determining part 203. FIG. 2 is waveforms exemplarily showing all sorts of the input listening audio and audio kinds sorted in the audio kinds sorting part 103 of the preprocessing part 100, and the most similar feature to the feature of the listening audio is searched from all sorts of audio features.

The pattern-matching part 202 matches the feature of the listening audio with the features according to the audio kinds by using a public technology such as dynamic programming, HMM (Hidden Markov Model) method, neural network method, etc.

In the above, the dynamic programming is a method for computing the similarity between two patterns while flexibly responding to a sample voice representing voice mode and a time axis of input voice. The HMM is method expressing as a transition probability that voice state is changed from a current state to a next state, and this method reflects time characteristic of audio well and is widely used in voice recognition.

The audio sorting determining part 203 determines an audio kind that is the most similar to the feature of the listening audio from a result of the pattern-matching part 202 and outputs the determined audio kind to the audio mode switching part 204. The audio mode switching part 204 automatically switches the current listening audio mode into an audio mode corresponding to the determined audio kind.

As described above, according to the method of the present invention, the listening audio kinds (music, sport, drama) are automatically recognized and switched into the audio mode optimal to the respective audio kinds. Therefore, the listener can listen the audio while enjoying the best sound effect without switching the audio mode in person.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for automatically switching an audio mode, the apparatus comprising:
a preprocessing part for collecting sample audio data in advance, then analyzing a feature of the sample audio data and extracting features according to kinds of audios; and
an audio mode determining part for pattern-matching an input listening audio feature with the features according to the kinds of audios to determine the kind of the listening audio and automatically switch the audio mode according to the determined audio kind.

2. The apparatus of claim 1, wherein the preprocessing part comprises:
a sample audio database for collecting and storing the sample audio data;
a first feature extracting part for extracting the features of the sample audio data stored in the sample audio database; and
an audio kinds sorting part for sorting the features of the sample audio data extracted from the first feature extracting part according to preset audio kinds.

3. The apparatus of claim 2, wherein the first feature extracting part extracts the features of the sample audio data by using any one selected from the group consisting of ICA (Independent Component Analysis), PCA (Principle Component Analysis), clustering, and vector quantization.

4. The apparatus of claim 2, wherein the audio kinds sorting part sorts the audio kinds by using either a learning model or a statistical model.

5. The apparatus of claim 1, wherein the audio mode determining part comprises:
a second feature extracting part for extracting the feature of the listening audio if the listening audio is inputted;
a pattern matching part for pattern-matching the feature of the listening audio with the features according to the kinds of audios sorted by the preprocessing part;
an audio sorting determining part for determining an audio kind that is the most similar to the feature of the listening audio from a result of the pattern-matching of the pattern-matching part; and
an audio mode switching part for automatically switching a current listening audio by using an audio mode of the audio kind determined from the audio sorting determining part.

6. The apparatus of claim 5, wherein the second feature extracting part extracts the features of the listening audio by using any one selected from the group consisting of ICA (Independent Component Analysis), PCA (Principle Component Analysis), clustering, and vector quantization.

7. The apparatus of claim 5, wherein the pattern-matching part utilizes any one selected from the group consisting of dynamic programming, HMM (Hidden Markov Model) method, and neutral network method.

8. A method for automatically switching audio mode, the method comprising the steps of:
(a) collecting sample audio data in advance, then analyzing a feature of the sample audio data and extracting features according to kinds of audios; and
(b) if a listening audio is inputted, pattern-matching a feature of the listening audio with the features according to the kinds of audios in the step (a) to determine the kind of the listening audio and automatically switch the audio mode according to the determined audio kind.

9. The method of claim 8, wherein the step (a) comprises the steps of:
collecting and storing the sample audio data;
extracting features of the stored sample audio data; and
sorting the features of the extracted sample audio data according to preset audio kinds.

10. The method of claim 9, wherein the extracting step is performed by any one selected from the group consisting of ICA (Independent Component Analysis), PCA (Principle Component Analysis), clustering, and vector quantization.

11. The method of claim 9, wherein the sorting step is performed by either a learning model or a statistical model.

12. The method of claim 8, wherein the step (b) comprises the steps of:
extracting the feature of the listening audio if the listening audio is inputted;
pattern-matching the feature of the listening audio with the features according to the kinds of audios sorted in the step (a);
determining an audio kind that is the most similar to the feature of the listening audio from the pattern-matching; and
automatically switching a current listening audio by using an audio mode of the determined audio kind.

13. The method of claim 12, wherein the step of extracting the listening audio is performed by any one selected from the group consisting of ICA (Independent Component Analysis), PCA (Principle Component Analysis), clustering, and vector quantization.

14. The method of claim 12, wherein the pattern matching step is performed by using any one selected from the group consisting of dynamic programming, HMM (Hidden Markov Model) method, and neutral network method.
